(19) United States
(12) Patent Application Publication
(10) Pub. No.: US 2019/0204449 A1
(43) Pub. Date: Jul. 4, 2019

(54) ANTI-COLLISION SYSTEMS AND METHODS OF USING THE SAME

(71) Applicant: SECURAPLANE TECHNOLOGIES, INC., Oro Valley, AZ (US)

(72) Inventors: Douglas Yuk, Fremont, CA (US); Jamie Clive Marshall, Tucson, AZ (US); Michael Boost, Tucson, AZ (US)

(73) Assignee: Securaplane Technologies, Inc

(21) Appl. No.: 16/233,909

(22) Filed: Dec. 27, 2018

Related U.S. Application Data
(60) Provisional application No. 62/612,423, filed on Dec. 30, 2017.

(51) Int. Cl. G01S 17/93; G01S 17/08; G08G 5/06

(52) U.S. Cl. CPC G01S 17/933; G08G 5/065; G01S 17/08

(57) ABSTRACT

An anti-collision system for an aircraft is provided. The anti-collision system preferably comprising a plurality of LIDAR sensors installed on the aircraft wherein each LIDAR sensor in the plurality of LIDAR sensors has a wide horizontal field of view and a small vertical field of view; a battery in electrical communication with the plurality of LIDAR sensors; a processor in electrical communication with the LIDAR sensors; a siren coupled to the aircraft and in electrical communication with the processor; and a keypad in electrical communication with the battery and processor and coupled to the aircraft.

### CROSS-REFERENCE TO RELATED APPLICATION

This patent document claims the benefit of and priority to U.S. Provisional Application Ser. No. 62/612,423, filed Dec. 30, 2017, the contents of which are incorporated herein by reference in their entirety and are to be considered a part of the specification.

### FIELD

This patent document relates to methods and systems for anti-collision. In particular, this patent document relates to an anti-collision system for aircraft and methods of using the same. The anti-collision systems described herein may be used to prevent collision both in flight and on the ground.

### BACKGROUND

In general, there are numerous reasons why collision detection and prevention are important. One very important category of collision detection relates to the use of aircraft. A collision with a foreign object has the potential to be catastrophic for the aircraft. Even if the collision is not catastrophic, it has the potential to inflict serious damage. Even if serious damage is not inflicted, a full check of the aircraft may need to be performed subsequent to the collision causing loss of flight time and revenue.

Collisions can happen anywhere and not just when the aircraft is in flight. Collision can happen on the taxiway or in and around the airport when the aircraft is taxiing.

To this end, anti-collision systems can be a valuable asset, especially to aircraft. Anti-collision systems that fix, or at least alleviates, some of the issues with current anti-collision systems is desirable.

Accordingly, it would be useful to demonstrate new and better techniques for preventing collisions and new and better anti-collision systems.

### SUMMARY OF THE EMBODIMENTS

Objects of the present patent document are to provide an improved apparatus and methods for preventing collisions and especially preventing collisions with aircraft. The collision systems described herein may be useful for preventing collisions both in flight and on the ground during taxiing. To this end, various embodiments of anti-collision systems and methods of use are provided. In some embodiments, the anti-collision system comprises: a plurality of LIDAR sensors installed on the aircraft wherein each LIDAR sensor in the plurality of LIDAR sensors has a field of view that is at or above the top of the landing gear and wherein each LIDAR sensor in the plurality of LIDAR sensors has a wide horizontal field of view and a small vertical field of view; a battery in electrical communication with the plurality of LIDAR sensors; a processor in electrical communication with the LIDAR sensors; a siren coupled to the aircraft and in electrical communication with the processor; and a keypad in electrical communication with the battery and processor and coupled to the aircraft wherein the keypad is located on a bottom fourth of a fuselage of the aircraft.

In some embodiments, the system further comprises a plurality of accelerometers in electrical communication with the processor. The accelerometers may be used to determine when the aircraft transitions from a stationary state to a moving state. This information may be used to wake up the anti-collision system. In addition to accelerometers, the system may also include one or more gyroscopes to allow the system to determine if the aircraft is stationary or moving. In preferred embodiments, both the accelerometers and gyroscopes may be Micro Electrical Mechanical Systems (“MEMS”) devices.

In some embodiments, the system further comprises a strobe light coupled to the aircraft and in electrical communication with the processor. The strobe light is preferably on the exterior of the aircraft or at least visible from the exterior of the aircraft so it may be used by ground personnel.

Some embodiments of the anti-collision system have a battery that is a dedicated battery exclusively for use by the anti-collision system.

Because one of the important benefits of the system is its use by ground personnel, the keypad is preferably located on the bottom and the exterior of the fuselage. In yet other embodiments, the keypad may be located on the bottom eighth of the fuselage. The taller the aircraft, the lower on the fuselage the keypad is preferably located. In embodiments where the keypad is located on an exterior of the aircraft, the keypad must be weatherproof or in an enclosure. Depending on the location of the keypad, the keypad may be waterproof.

In various different embodiments, the sensors in the plurality of LIDAR sensors may be configured in different ways. In one embodiment, each sensor in the plurality of LIDAR sensors is daisy chained in an array. In other embodiments, they are all directly connected to the processor and the processor may treat them as an array.

### BRIEF DESCRIPTION OF THE DRAWINGS

FIG. 1 illustrates an exterior view of aircraft with a LIDAR system including an external keypad or button and a siren, strobe light or both.

FIG. 2 illustrates a top down view of an aircraft with the fields of view of the various LIDAR arrays shown.

FIG. 3 illustrates a schematic of the state machine for a LIDAR anti-collision system.

FIG. 4 illustrates a keypad and button integrated into the exterior skin of the aircraft for activating and controlling the LIDAR system.

### DETAILED DESCRIPTION OF THE DRAWINGS

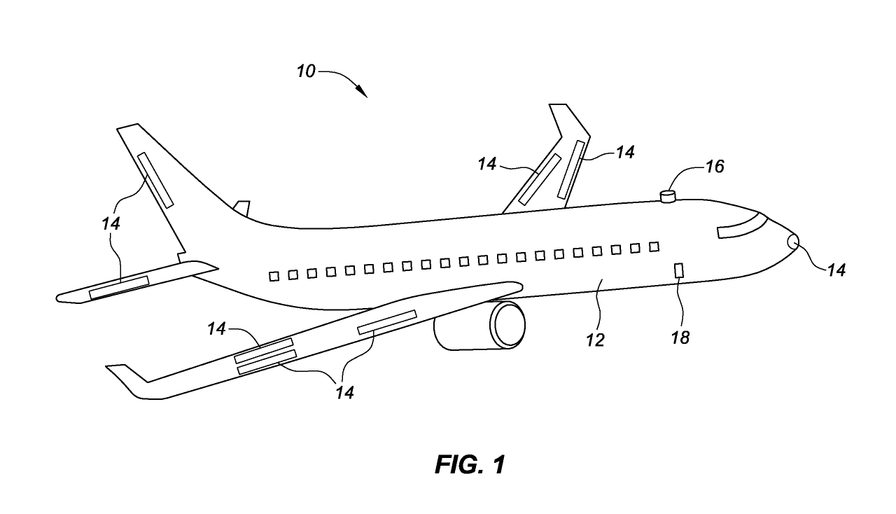

The present patent document describes embodiments of anti-collisions systems and methods of making and using anti-collision systems. FIG. 1 illustrates an exterior view of aircraft 12 with a Light Detection And Ranging (“LIDAR”) system 10 including a plurality of LIDAR detectors 14, external keypad or button 18, and a siren, strobe light or both 16. The anti-collision system may be used for any purpose but may be used with aircrafts to prevent the aircraft from colliding with objects, such as birds, mountains, towers or other aircraft, to name a few. In preferred embodiments, the LIDAR system is employed on the ground during taxing or parking to prevent collision with other aircraft, towers or buildings, other ground vehicles, or other ground obstacles.

In embodiments designed for aircraft 12, a plurality of LIDAR sensors 14 are mounted on the aircraft 12. The LIDAR sensors 14 may be mounted anywhere on the aircraft 12 including the nose, the fuselage, leading edge of the wings, rear edge of the wings, horizonal stabilizer, vertical stabilizer, wing tips, landing gear or anywhere else on the aircraft. FIG. 1 illustrates various position for LIDAR sensors 14 but other locations may be used. It should be understood that the locations listed above may be used in various combinations. Embodiments may exist with any combination of the locations discussed and any subset thereof along with other locations not listed.

FIG. 1 shows a plurality of locations 14 for LIDAR detectors. However, each location may consist of a LIDAR array. A LIDAR array is just a plurality of LIDAR sensors designed to work together as a larger sensor. LIDAR arrays can be a group of sensors placed out of plane with each other so they are tilted at different angles. In other embodiments, the LIDAR sensors within the array may be in plane but have a sync pulse connected between the sensors so they will coordinate amongst themselves to avoid interference. In yet other embodiments, the LIDAR arrays may be constructed in other ways.

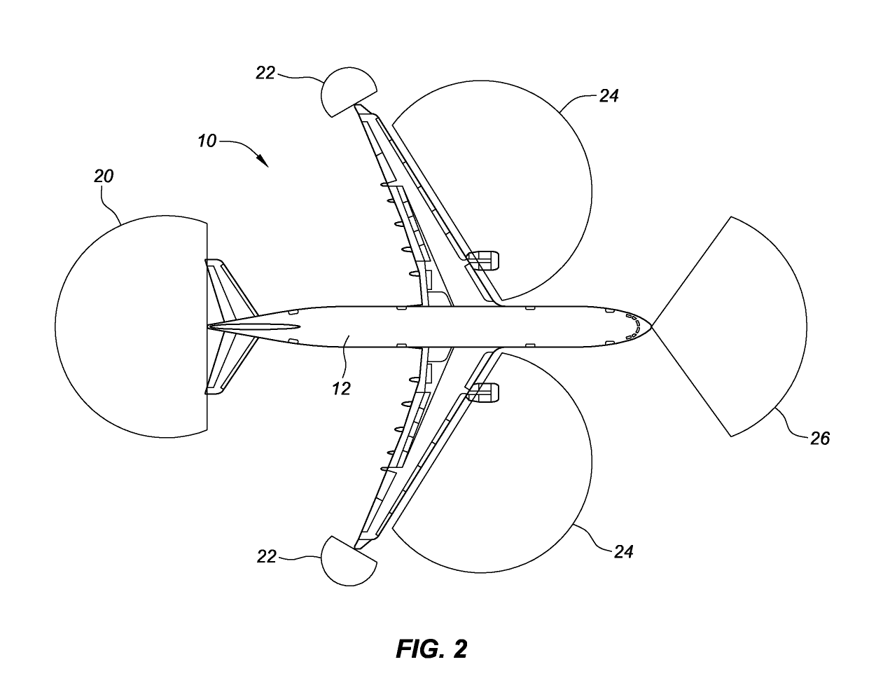

FIG. 2 illustrates a top down view of an aircraft 12 with the fields of view 20, 22, 24 and 26 of the various LIDAR arrays shown. The illustrations in FIG. 2 is meant to just generally show various directions and areas for LIDAR to acquire a field of view. In some embodiments the LIDAR systems may have significantly farther fields of view. For systems designed to prevent in flight collisions, fields of view that extend substantially farther away from the aircraft 12 are needed. For systems 10 designed to handle ground collisions, fields of view limited to much closer to the aircraft 12 may be used due to the much slower speeds. In preferred embodiments, LIDAR systems with both near and far fields of view may be used.

In some embodiments, a LIDAR array is oriented in a way such that a circular sector region ( [symbol] ) behind the empennage of the aircraft is within the sensing field of view 20 for the array of LIDAR sensors. In yet other embodiments, there may be a LIDAR sensor or array positioned on the aircraft to create a field of view off one or more wing tips 22. In still other embodiments, there may be LIDAR sensors or arrays positioned on, or near, the leading edge of the aircraft to create a sector shaped field of view of one or more wing leading edges 24. In still yet other embodiments, there may be LIDAR sensors or arrays positioned on or near the nose of the aircraft to create a LIDAR field of view in front of the aircraft 26. In yet other embodiments, LIDAR sensors or arrays may be located in other areas to create other fields of view around the aircraft.

In many embodiments, the field of may be pie shaped or sector shaped but the LIDAR sensors may be positioned and deployed in various different ways to create different shaped fields of view. In some embodiments, the sensor and/or arrays may include scanning mirrors to help shape the field of view. Within each field of view, the system can sense objects and calculate collision detection and collision avoidance parameters.

In preferred embodiments, the LIDAR sensors are pointed outward from the plane. Preferably, the LIDAR sensors and/or arrays are aimed parallel to the ground at the same height as the tail-plane or horizontal stabilizers. The height of the sensors will depend on where on the plane they are attached. For example, sensors and/or arrays attached by the wings will naturally be at the height of the wings. Preferably, the sensors field of view is parallel to the ground and at or above the top of the landing gear. In some embodiments, the sensors and/or arrays can be angled to change the plane of the field of view.

As mentioned, the LIDAR sensors and arrays can be configured to create a field of view in any desired three-dimensional space. However, in preferred embodiments, each LIDAR sensor has a wide horizontal field of view and a small vertical field of view and can be classified as a two-dimensional solid-state sensor. For example the horizontal field of view may be 4 times, 8 times, 10 times, 20 times or even 100 times the width of the vertical field of view.

The LIDAR systems 10 may have a dedicated battery and processing unit. In other embodiments, the LIDAR systems 10 may be connected to the aircraft power. In yet other systems, each LIDAR sensor may have its own power source such as a power storage system that creates electricity from the kinetic energy of the plane and stores that electricity in a capacitor or battery or both.

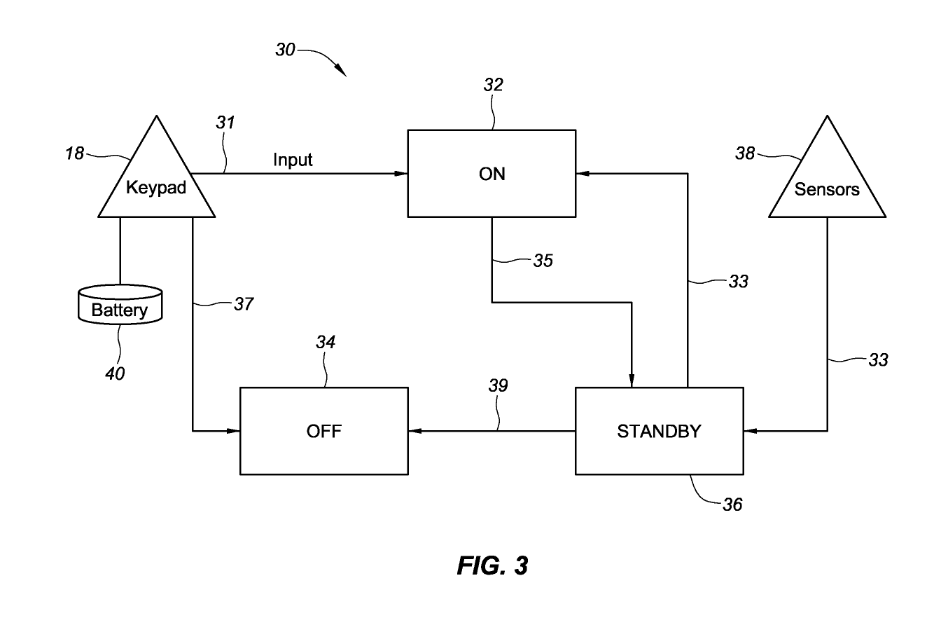

FIG. 3 illustrates a schematic of the state machine 30 for a LIDAR anti-collision system 10. In preferred embodiments, the anti-collision system 10 operates in three states; On 32, Standby 36, and Off 34. In operation, the On state 32 is activated from the Off 34 state by input 31 from the external keypad 18. In preferred embodiments, keypad 18 is powered by a dedicated battery 40. However, in other embodiments, keypad 18 may be powered by aircraft power or some other power system as explained above.

The activation command cues the power system to provide power to the processing unit, the LIDAR array(s) 14 and the siren/strobe light 16. Alternatively, the On state 32 is activated from the Standby state 36 by a signal 33 generated by the detection of motion of the aircraft. Accelerometers, gyroscopes or other sensors 38 may be incorporated into the system 10 to perform motion detection and cue 33 the transition from the Standby state 36 to the On state 32. In preferred embodiments, the accelerometers and gyroscopes or other sensors may be MEMS sensors.

In the On state 32, distance measurement information is continually received from the LIDAR sensors 14 and passed either wirelessly or through a communication cable from the LIDAR sensors 14 to a processing unit, which is preferably located within the aircraft fuselage. In preferred embodiments, only a single processing unit is used.

The LIDAR sensors 14 can be either individually connected to the processing unit or connected to each other in a ‘daisy-chain’. The processing unit is responsible for receiving the LIDAR data and processing the data to determine the minimum distance from the aircraft 12 to the nearest detected object using a proprietary algorithm. The software algorithm within the processing unit processes the data received from the LIDAR sensors once it has been activated.

In preferred embodiments, alert thresholds may be set either through a screen or from the keypad 18. Thresholds set the minimum distance that must be maintained between a point on the aircraft 12 and a potential obstruction or object. In preferred embodiments, there may be different thresholds for in flight and ground operations. In other embodiments, the thresholds may automatically adjust based on the speed of the aircraft 12. In preferred embodiments, different thresholds may also exist for different portions of the aircraft 12. For example, the wings may have a smaller threshold than the back of the tail.

Upon detection of at least one object within the threshold in the total field of view, the processing unit annunciates to the ground crew the distance measurement to the nearest object by activating the strobe light and/or the external siren 16. In some embodiments, the intermittency of the siren and/or strobe 16 shall indicate to the ground crew the distance to the nearest object, whereby a slow intermittency indicates a larger distance, a rapid intermittency indicates a smaller distance and an uninterrupted tone indicates a critical distance. In yet other embodiments, a computer voice may call out the distances.

The Standby state 36 is activated 35 from the ON state 32 upon time-out (where no changes in distance above a defined threshold are detected by the LIDAR array in a given time period). When the system is in the Standby state 35, system functionality is limited but the keypad 18 is still responsive.

In the Off state 34, the anti-collision system is powered down with the exception of the external keypad 18. During the On state 32, the Off state 34 is activated 37 by input to the external keypad 18. In the Standby state 36, the Off state 34 is activated 37 by time-out (where no changes in distance above a defined threshold are detected by the LIDAR array in a given time period.) LIDAR is not active in the standby state.

In some embodiments, there may be multiple ON states where different quantities of LIDAR are active. For example, only the front LIDAR sensors are active if the aircraft is moving forward and only the rear LIDAR sensors are active if the aircraft are moving backward.

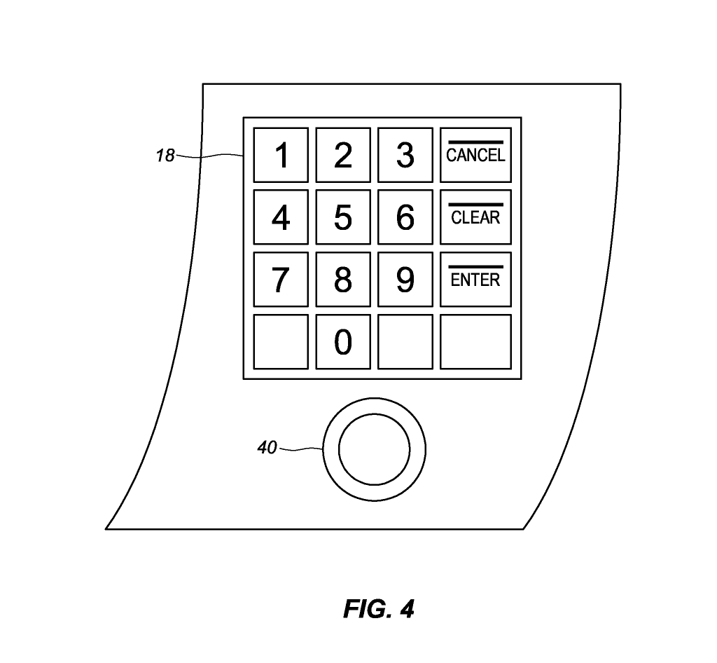

FIG. 4 illustrates a keypad 18 and button 40 integrated into the exterior skin of the aircraft for activating and controlling the LIDAR system 10. In some embodiments, only a keypad 18 is used and in other embodiments, only a button 40 is used.

In preferred embodiments, the keypad 18 and or button 40 are exposed to the exterior of the aircraft (or recessed behind a panel) such that they may be operated by ground personnel. In preferred embodiments, the exterior controls are placed low enough on the fuselage that they may be easily operated by ground personnel. Accordingly, in some embodiments the keypad 18 and button 40 are located on the bottom of the fuselage such that they may be reached by ground personnel. In yet other embodiments, the keypad 18 button 40 may be located on the bottom fourth of the fuselage. In still yet other embodiments, the keypad 18 and button 40 may be located on the bottom eight of the fuselage.

Parallel controls to the keypad 18 and button 40 may also be located in the cockpit such that they can be operated by the pilots. In preferred embodiments, the keypad 18 and/or button 40 are of a waterproof design to prevent contamination from the elements. In addition, aircraft have to survive extreme temperatures. Very hot temperatures on the tarmac in the summer and very cold temperatures at altitude or on the ground in the winter. Accordingly, the keypad is designed to work in a wide temperature range including down to −40° C.

What is claimed is:

1. An anti-collision system for an aircraft comprising:
a plurality of LIDAR sensors installed on the aircraft wherein each LIDAR sensor in the plurality of LIDAR sensors has a field of view that is at or above the top of the landing gear and wherein each LIDAR sensor in the plurality of LIDAR sensors has a wider horizontal field of view than a vertical field of view;
a battery in electrical communication with the plurality of LIDAR sensors;
a processor in electrical communication with the LIDAR sensors;
a siren coupled to the aircraft and in electrical communication with the processor; and
a keypad in electrical communication with the battery and processor and coupled to the aircraft wherein the keypad is located on a bottom fourth of a fuselage of the aircraft.

2. The system of claim 1, further comprising a plurality of accelerometers in electrical communication with the processor.

3. The system of claim 2, further comprising a strobe light coupled to the aircraft and in electrical communication with the processor.

4. The system of claim 3, wherein the battery is a dedicated battery exclusively for use by the anti-collision system.

5. The system of claim 4, wherein the keypad is located on the bottom eighth of the fuselage.

6. The system of claim 5, wherein the keypad is accessible from an exterior of the aircraft.

7. The system of claim 6, wherein the keypad is water proof.

8. The system of claim 1, wherein each sensor in the plurality of LIDAR sensors is daisy chained in an array.

9. An anti-collision system for an aircraft comprising:
a plurality of LIDAR sensors installed on the aircraft wherein each LIDAR sensor in the plurality of LIDAR sensors has a field of view that is at or above the top of the landing gear and wherein each LIDAR sensor in the plurality of LIDAR sensors has a wider horizontal field of view than a vertical field of view and wherein a circular sector region behind the empennage of the aircraft is within the field of view;
a battery in electrical communication with the plurality of LIDAR sensors;
a processor in electrical communication with the LIDAR sensors;
a siren coupled to the aircraft and in electrical communication with the processor; and
a keypad in electrical communication with the battery and processor and coupled to the aircraft wherein the keypad is located on a bottom fourth of an exterior of a fuselage of the aircraft.

10. The system of claim 9, further comprising a plurality of accelerometers in electrical communication with the processor.

11. The system of claim 10, further comprising a strobe light coupled to the aircraft and in electrical communication with the processor.

12. The system of claim 11, wherein the battery is a dedicated battery exclusively for use by the anti-collision system.

13. The system of claim 12, wherein the keypad is located on the bottom eighth of the fuselage.

14. The system of claim 13, wherein the keypad is water proof.

15. The system of claim 14, wherein each sensor in the plurality of LIDAR sensors is daisy chained in an array.

16. An anti-collision system for an aircraft comprising:
a plurality of LIDAR sensors installed on the aircraft wherein each LIDAR sensor in the plurality of LIDAR sensors has a wider horizontal field of view than a vertical field of view;
a battery in electrical communication with the plurality of LIDAR sensors;
a processor in electrical communication with the LIDAR sensors;
a siren coupled to the aircraft and in electrical communication with the processor;
a plurality of accelerometers in electrical communication with the processor; and
a keypad in electrical communication with the battery and processor and coupled to the aircraft wherein the keypad is located on a bottom fourth of an exterior of a fuselage of the aircraft.

17. The system of claim 16, further comprising a strobe light coupled to the aircraft and in electrical communication with the processor.

18. The system of claim 17, wherein the keypad is water proof.

19. The system of claim 18, wherein each sensor in the plurality of LIDAR sensors is daisy chained in an array.
